(19) United States
(12) Patent Application Publication
(10) Pub. No.: US 2003/0026446 A1
(43) Pub. Date: Feb. 6, 2003

(54) Telescoping articulating boom pole

(76) Inventor: Andrew Jefferson Davis, Greenbrier, TN (US)

Correspondence Address: Andrew J. Davis, 2017 Shawnee Lane, Greenbrier, TN, 37073, US

(21) Appl. No.: 09/918,846

(22) Filed: Jul. 31, 2001

(51) Int. Cl. H04R 5/02; H04R 1/20

(52) U.S. Cl. 381/390; 381/306; 381/338; 381/339; 381/387

(57) ABSTRACT

A telescoping, articulating boom pole (20) is disclosed, including articulating joints (24), telescoping tube pairs (28), a boom butt (30), and a stud (32). Individual telescoping tube pairs (28) include outer and inner telescoping tubes (38 and 40) and a locking collar (36). The locking collar (36) holds the outer and inner telescoping tubes (38 and 40) in juxtaposition. The articulating joints (24) connect the telescoping tube pairs (28). The articulating joints (24) include first and second joint heads (42 and 44), a joint link plate (46), and bolts (48). The joint link plate (46) mates with the joint heads (42 and 44). The joint link plate (46) is held in place against the joint heads (42 and 44) by the bolts (48). Articulation between the joint heads (42 and 44) and the joint link plate (46) allows the telescoping tube pairs (28) to be juxtaposed at various angles to one another, and allows the boom pole (20) to be collapsed. The stud (32) is attached at the microphone end of the boom pole. The boom butt (30) is attached at the operator end of the boom pole (20) via the articulating joint (24). The boom butt (30) includes a chamber (56) designed to accept typical equipment mounting devices (not shown) found in the television and film industries. Locking knobs (58), designed to apply pressure to mounting devices (not shown), insert into the chamber (56) via apertures (60).

### CROSS REFERENCE TO REALTED APPLICATIONS

N/A

### STATEMENT REGARDING FED SPONSORED R&D N/A

### REFERENCE TO SEQUENCE LISTING

N/A

### BACKGROUND

1. Field of the Invention

The present invention relates generally to a boom pole designed for suspending and positioning a microphone and/or a small camera, and more particularly, but not by way of limitation, to an improved and novel audio boom pole having a wide range of articulation and mounting capability, to facilitate accurate and precise microphone and/or small camera orientation, with or without a boom pole operator.

2. Brief History of the Art

Microphone boom poles are used to suspend, position, and aim a microphone for the purpose of recording sound. There are two basic prior art constructions of microphone boom poles. The first construction, generally referred to as a “studio boom”, is typically large, independently mounted on a mobile platform, structurally complex, and practical only in large studio or field production environments. The second, generally referred to as a “fishpole” boom, is a hand-held, linear construction consisting of hollow, tubular telescoping pairs that can be lengthened or shortened.

The studio boom pole is similar in construction to the fishpole boom. A microphone is attached to one end of a telescoping boom that positions the microphone by lengthening, shortening, panning, and tilting. However, the boom pole is mounted on a support extending vertically from a platform or other support device that can often be raised or lowered. The studio boom is generally large, cumbersome, complex, and offers little versatility in its present construction.

A hand-held boom pole, or fishpole, is held and manipulated by a person generally referred to as the boom operator. A microphone is mounted at one end of the boom pole in a fixed position. The operator manipulates the other end of the boom pole to position and aim the microphone. The audio cable can be external of the boom, or housed within it and threaded through exit points at either end of the boom. Due to its simplicity, the hand-held boom pole is easier to operate than the studio boom. Since an operator who may move about holds and manipulates the boom, it also is more portable and more versatile than the studio boom.

The hand-held boom pole has two primary weaknesses: It utilizes a fixed linear construction, and it is primarily limited to hand-held operation.

Several difficulties are encountered with traditional prior art hand-held boom pole constructions. Microphones used in the film, television, and news industries must often be placed in exact locations on the set, or when shooting on the fly, be positioned quickly in awkward situations yet remain out of the shot. Because of its fixed linear construction, the traditional hand-held boom pole cannot be articulated in order to accommodate tight places or obstacles such as lighting equipment, light beams, production equipment, scenery, the camera “frame”—the actual viewing area on a TV screen—cranes, and a host of other production equipment used to shoot a typical film or television production. For example, U.S. Pat. No. 5,454,042 to Drever (1995) discloses a boom apparatus that can be lengthened or shortened by way of the telescoping sections, but remains a straight, fixed pole with limited flexibility. The fixed, linear construction of the traditional hand-held boom pole becomes problematic when shooting on the fly in awkward or tight shooting situations.

In order to avoid “getting into the shot”, the boom operator often has to hold the boom pole over his or her head in a horizontal position, with both arms extended, for long periods of time. Fatigue often takes its toll on the arms in this situation, and the boom “drifts” into the shot. On almost any production set, you often will repeatedly hear the phrase “Cut: boom in the shot” or “Cut: boom shadow” because of fatigue-related boom pole drift. Even though the boom shown in U.S. Pat. No. 5,454,042 to Drever (1995) may be elevated in order to get over the camera “frame”, the vertical distance it travels is still limited to the length of the operator's arms, and it also requires the operator's arms to be raised above the head for extended periods of time. Because of the vertical pivotal support, the overhead nature of the boom represented in U.S. Pat. No. 5,454,042 to Drever (1995) does help to prevent the microphone from drifting into the shot, but because the arms must still be held overhead, downward pressure on the butt of the boom by an exhausted operator can cause the microphone to drift out of audible range of the talent, which decreases the quality of live or recorded audio, or requires the audio engineer to constantly “ride” the levels to adjust for the floating microphone.

Because of the fatigue problem in the arms, panning the microphone from one person to another in the shot without allowing the boom to drift into the shot is difficult and cumbersome when using a straight, traditional hand-held boom pole in an overhead position. This overhead fatigue problem is a standard characteristic of all straight, handheld boom poles.

Because of the fixed, linear nature of traditional boom poles and their inability to be articulated to “fit around the frame”, they often “clip” the corners of the frame in news media and other events shot on the fly, consequently presenting a cluttered, messy scene to the public.

Traditional hand-held boom poles also must be held and manipulated by a boom operator. Traditional hand-held boom poles have no built-in technology that allows versatile static mounting of the boom pole. It is often the case that a microphone requires static mounting in a specific location on the set. If unanticipated equipment limitations require the use of the boom operator's boom pole in order to mount a microphone in a static position, the traditional boom pole must be held with clamps. Due to the delicate nature of the tubing utilized in a hand-held boom in order to reduce weight, clamps can permanently damage a hand-held boom and render it inoperable. Boom operators will often ask the lighting technician or gaffer on a shoot to bring an extra lighting stand or “C-Stand” to be used as a makeshift microphone rig. Even though booms such as the ones shown in U.S. Pat. Nos. 4,671,478 to Schoenig/Lindskog (1987), and 5,611,508 to Palmero (1997) are static mounted, they offer little versatility or creativity in mounting options.

Due to their linear nature, even if static mounting is possible, traditional hand-held boom poles offer little versatility when mounted in a static position because of a lack of articulation ability.

All traditional hand-held and studio booms heretofore known suffer from a lack articulation between their sections.

### SUMMARY OF THE INVENTION

The disadvantages and limitations of the background art discussed above are overcome by the present invention. The present invention provides, in a preferred embodiment, a novel boom pole construction of the invention wherein the boom pole is composed of telescoping tube pairs connected by articulating joints. The sections of each telescoping tube pair are locked into place relative to one another by way of a locking collar standard in the industry. Each articulating joint is composed of two joint heads, a joint link plate, and devices that secure the link plate to the joint heads. Corrugated faces on each joint head and link plate allow an interlocking interface between them. The devices that secure the joint heads and the joint link plate extend through apertures in either end of the link plate and secure into apertures in the individual joint heads. The butt of the preferred embodiment utilizes a mounting device having a chamber designed to mate with any of several standard types of equipment used in the television, film, and news industries. The shafts of two locking knobs extend through the mounting device wall and secure the device onto equipment used in the television, film, and news industries when the locking knobs are tightened. The mounting device is attached to the boom pole by an articulating joint. A device for mounting audio/video equipment is attached at the end of the boom pole opposite the butt.

### OBJECTS AND ADVANTAGES

Accordingly, besides the objects and advantages of the boom pole described in my above patent, several objects and advantages of the present invention are:

(a) to provide a novel boom pole utilizing telescoping tube pairs and articulating joints that provide a combination of rotation and articulation which allows the tube pairs to be positioned at various angles to one another in a way not possible with prior art.

(b) to allow a boom operator to position the microphone “up, over, around, or under” the camera, the frame, lighting or other equipment, and still hold the boom pole in a comfortable position for extended periods of time.

(c) to provide a boom pole that is easily held in a comfortable position with one hand.

(d) to provide a hand-held boom pole with the configuration flexibility necessary to keep it out of the shot when shooting film and video production work on the fly or in tight, awkward situations and still allow the operator to remain in a comfortable position.

(e) to provide a boom pole that allows the operator to control horizontal and vertical movements of the boom with one hand for extended periods of time without “getting into the shot,” and still remain in a comfortable position.

(f) to provide a boom pole that allows the operator to walk along beside the talent or camera on a “trucking shot” with the boom pole held at a comfortable position with one hand and keep the microphone at a workable height in relation to the frame while keeping the boom pole out of the frame.

(g) to provide a boom pole that allows the operator to follow closely behind or next to a camera in a comfortable position and keep the boom and microphone in one position relative to the talent while moving around the scene.

(h) to provide a wide range of flexibility in positioning microphones “around the frame” in television, film, and news production.

(i) to provide a boom pole that is capable of complex configurations that accommodate scenery, lighting stands and instruments, light beams, and a host of other production entities and problems commonly involved in the setup of a shot.

(j) to provide a marked increase in the degree of operator comfort associated with hand-held positioning of microphones for use in television, film and news production over that provided by traditional hand-held boom poles of the aforementioned type.

(k) to provide a device at the butt of the boom pole that accepts a standard mounting device found on various clamps and mounts designed for television, film and news production, which allows the boom pole to be easily mounted and positioned in a variety of locations heretofore not accessible with traditional boom poles.

(l) to provide an articulating joint at the butt of the boom pole that allows a variety of statically mounted configurations heretofore not available using traditional boom poles.

(m) to provide technology that allows the boom pole to be mounted statically for use without an operator.

(n) to provide a technology that can be applied to a wide range of quality and price ranges of boom poles.

(o) to provide a technology that can be applied to, and used to enhance, established R&D in prior art, and that produces minimal retooling for startup production in existing manufacturing situations.

Other objects of the present invention, as well as particular features, elements, and advantages thereof, will become apparent in the following description and drawings.

### BRIEF DESCRIPTION OF THE DRAWINGS

Understanding of the present invention and the various aspects thereof will be facilitated by reference to the accompanying drawing figures, submitted for purposes of illustration only and not intended to define the scope of the invention, in which:

FIG. 1 is a side elevation view of a microphone boom pole constructed according to the present invention.

FIG. 2 is an isometric rotation view of an articulating joint assembly and partial tube pairs with locking collars.

FIG. 3 is a detailed side elevation view of joint heads, a joint link plate, bolts, and partial view of tube pairs with locking collar.

FIG. 4 is a front elevation view of the joint link plate shown in FIG. 3.

FIG. 5 is a side elevation view of the joint heads shown in FIG. 3.

FIG. 6 is a cross-section view of the joint heads taken along line 14-14 in FIG. 5.

FIG. 7 is an isometric rotation view of the boom butt assembly and a partial tube pair with locking collar.

FIG. 8 is a side elevation view of the boom butt shown in FIG. 7.

FIG. 9 is a cross-section view of the boom butt taken along line 15-15 in FIG. 8.

### REFERENCE NUMERALS IN DRAWINGS

20 telescopic articulating boom pole

24 articulating joint

28 telescoping tube pair

30 boom butt

32 stud

34 aperture

36 locking collar

38 outer tube

40 inner tube

42 first joint head

44 second joint head

46 joint link plate

48 bolt

50 corrugated face

52 aperture

54 aperture

56 boom butt chamber

58 locking knob

60 aperture

### DETAILED DESCRIPTION OF THE PREFERRED EMBODIMENT

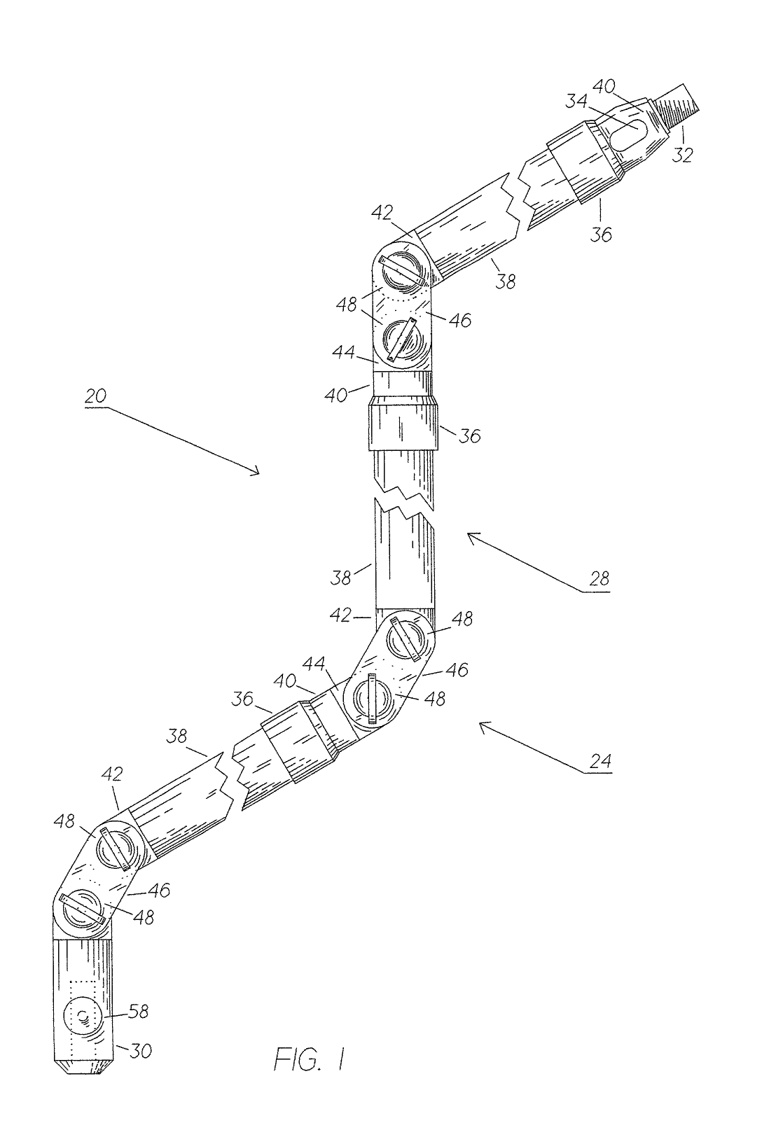

Referring more particularly to the drawings, in FIG. 1 there is shown the preferred embodiment of the invention, a telescoping, articulating boom pole generally indicated by the reference numeral 20. The boom pole 20 utilizes an articulating joint, generally indicated by the reference numeral 24. The articulating joint 24 connects telescoping tube pairs, generally indicated by the reference numeral 28, and allows the tube pairs 28 to be positioned at various angles to one another. A boom butt 30 is located at the operator end of the boom pole 20, and a stud 32 is located at the microphone end of the boom pole 20. An aperture 34 is located at the microphone end of the boom pole 20 to facilitate threading a microphone cable (not shown) inside the boom pole 20. A locking collar 36 is used to lock tube pair 28 outer and inner tubes 38 and 40 into place.

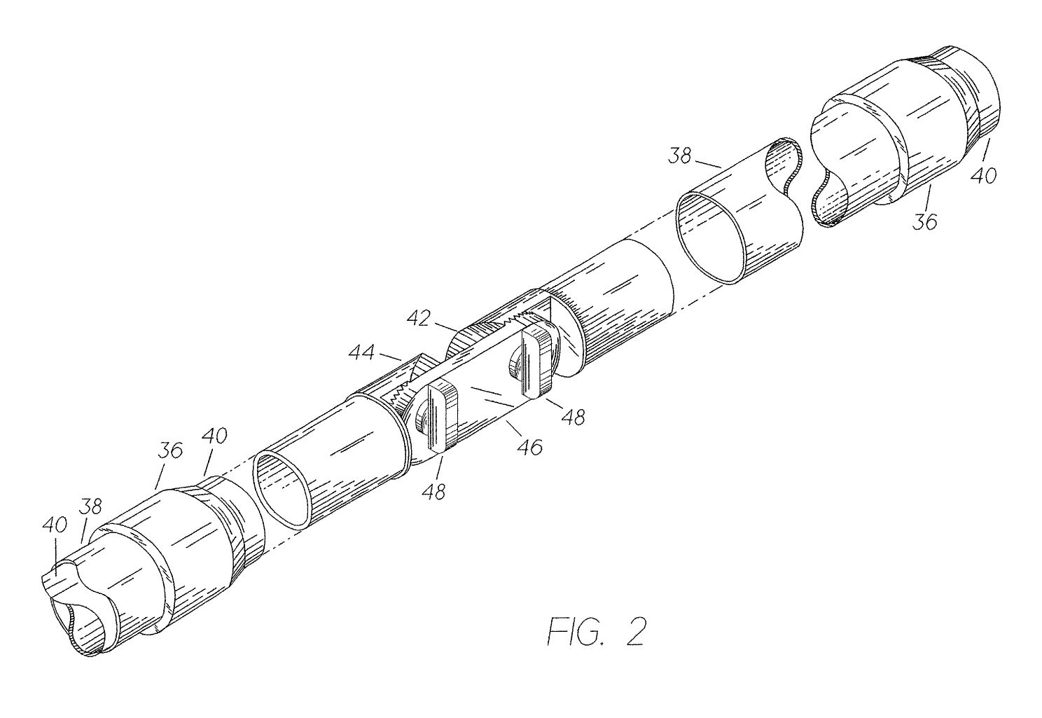

Referring now to FIG. 2, an isometric rotation view of the articulating joint 24 (FIG. 1) is shown. A first and second joint head 42 and 44 are connected utilizing a joint link plate 46 which interfaces with the first and second joint heads 42 and 44. The joint link plate 46 is secured against the first and second joint heads 42 and 44 by bolts 48. The first joint head 42 inserts into the outer tube 38 of the tube pair 28 (FIG. 1), and the second joint head 44 inserts into the inner tube 40 of the tube pair 28 (FIG. 1). The locking collar 36 locks individual outer and inner tubes 38 and 40 of the tube pair 28 (FIG. 1) into place.

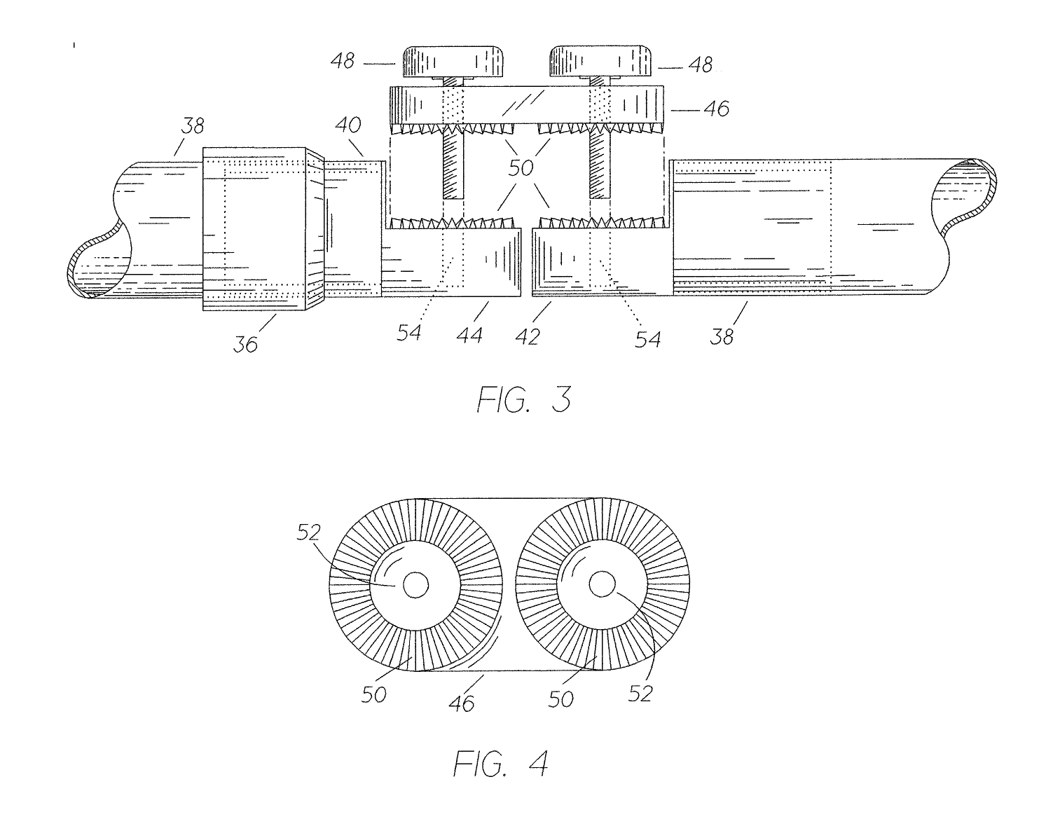

Referring now to FIG. 3, a detailed view of the articulating joint 24 (FIG. 1) is shown. The first joint head 42 inserts into the outer tube 38 of the tube pair 28 (FIG. 1) and is secured in a conventional manner. The second joint head 44 inserts into the inner tube 40 of the tube pair 28 (FIG. 1) and is secured in a conventional manner. The corrugated faces 50 on the joint link plate 46 and on the first and second joint heads 42 and 44 interface. Bolts 48 extend through apertures 52 (FIG. 4) in the joint link plate 46 and secure into apertures 54 in the first and second joint heads 42 and 44. The locking collar 36 locks individual outer and inner tubes 38 and 40 of the tube pair 28 (FIG. 1) into place.

Referring now to FIG. 4, a front elevation view of the joint link plate 46 is shown. Corrugated faces 50, and apertures 52 are also shown.

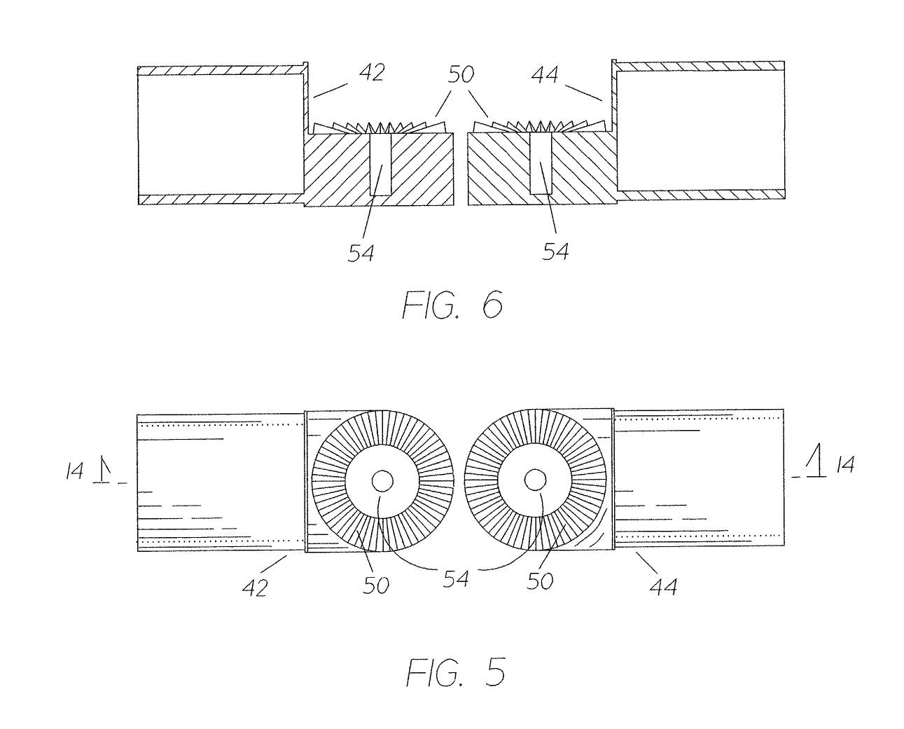

Referring now to FIG. 5, a front elevation view of the first and second joint heads 42 and 44 (FIGS. 2 and 3) is shown. Apertures 54 and corrugated faces 50 are shown.

Referring now to FIG. 6, taken along line 14-14 in FIG. 5, a section view of the first and second joint heads 42 and 44 is shown. Corrugated faces 50, as well as apertures 54 designed to accept bolts 48 (FIGS. 1, 2, 3, 7) are shown.

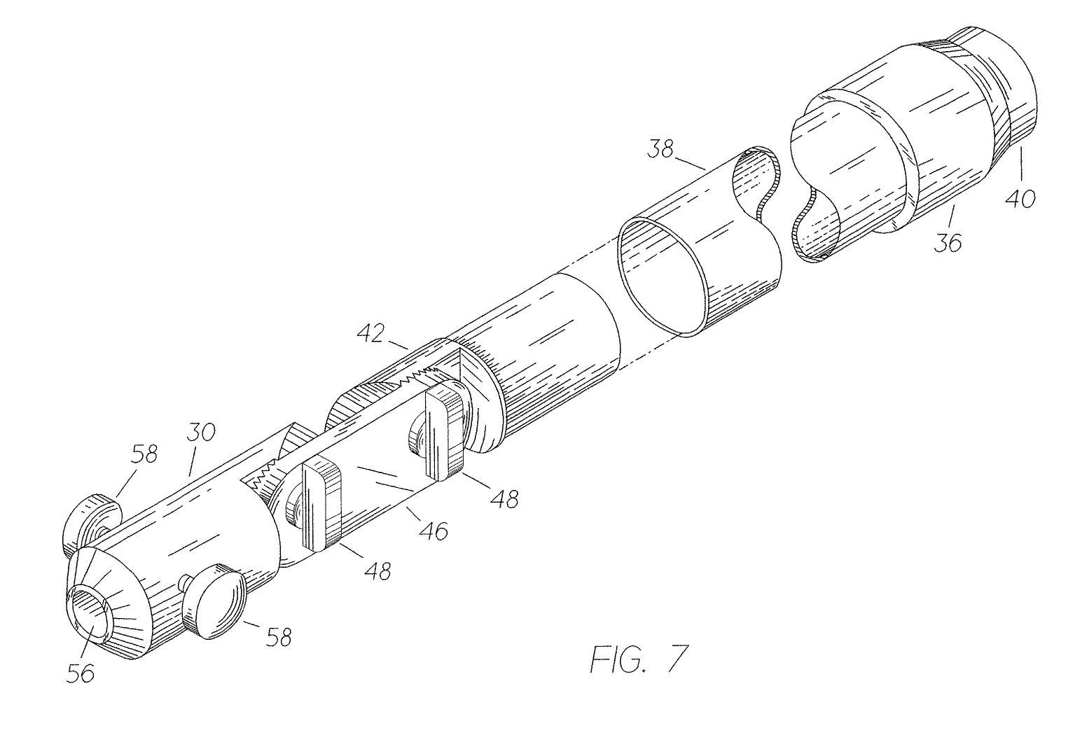

Referring now to FIG. 7, an isometric rotation view of the boom butt 30 (FIG. 1) and the articulating joint 24 (FIG. 1) is shown. The boom butt 30 is connected to the first joint head 42 utilizing the link plate 46 which is held in place against the boom butt 30 and the first joint head 42 by bolts 48. The first joint head 42 inserts into the outer tube 38 of a tube pair 28 (FIG. 1) at the operator end of the boom pole 20 (FIG. 1). The locking collar 36 locks the outer and inner tubes 38 and 40 of the tube pair 28 (FIG. 1) at the operator end of the boom pole 20 (FIG. 1) into place. A boom butt chamber 56 designed to mate with standard equipment (not shown) common to production work in the television and film industry is shown. Locking knobs 58, designed to lock the boom butt 30 onto equipment (not shown) common to production work in the television and film industry, are shown.

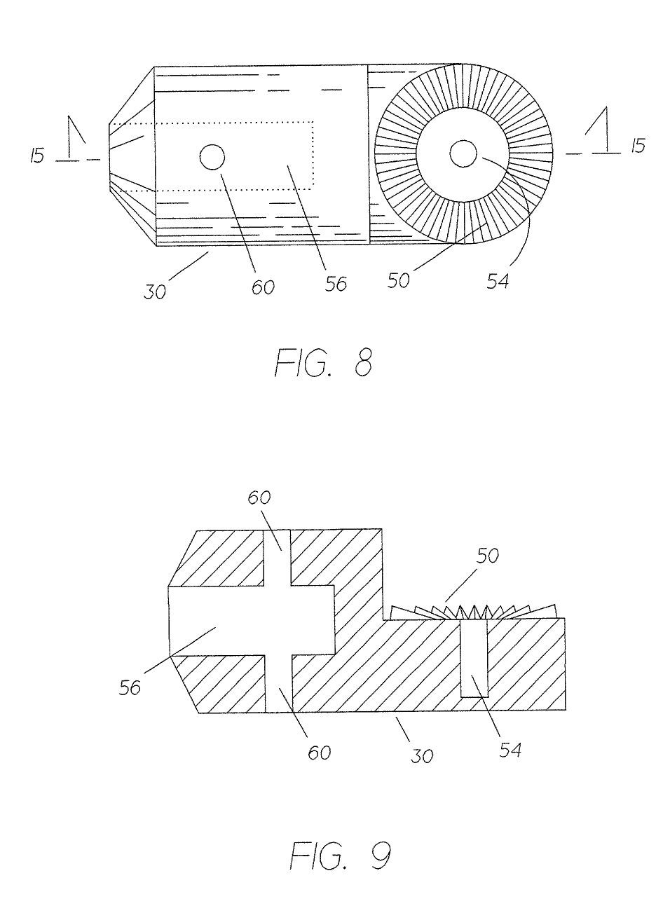

Referring now to FIG. 8, a front elevation view of the boom butt 30 is shown. Boom butt chamber 56 (FIG. 7) is shown. One of two apertures 60 designed to accept the locking knobs 58 (FIGS. 1, 2, 3, 7) is also revealed. Corrugated face 50 which interfaces with the joint link plate 46 (FIGS. 1, 2, 3, 7) is shown.

Referring now to FIG. 9, a cross-section of the boom butt 30, taken along line 15-15 in FIG. 8 is shown. The chamber 56 is designed to accept a mounting device (not shown) common to production work in the television and film industry. Apertures 60 accept locking knobs 58 (FIGS. 1, 2 3, 7). Aperture 54 accepts bolt 48 (FIGS. 1, 2, 3, 7). The corrugated face 50 interfaces with the joint link plate 46 (FIGS. 1, 2, 3, 7).

The objects set forth above, among those elucidated in, or made apparent from the preceding description, are efficiently attained. Since certain changes may be made in the above construction without departing from the scope of the invention, it is intended that all matter contained in the above description or shown on the accompanying drawing figures shall be interpreted as illustrative only and not in a limiting sense.

Operation—FIGS. 1, 2, 3, 7

The telescoping, articulating boom pole 20 (FIG. 1) may be collapsed and its tube pair 28 (FIG. 1) sections folded alongside one another for storage by loosing the locking collars 36, collapsing the individual tube pairs 28 (FIG. 1), and tightening the individual locking collars 36. Then loosen each pair of bolts 48 that hold each joint link plate 46 against first and second joint heads 42 and 44, fold the tube pairs 28 (FIG. 1) against one another, then tighten bolts 48.

To unfold and use the telescoping, articulating boom pole 20 (FIG. 1), loosen the bolts 48 that hold each joint link plate 46 against the first and second joint heads 42 and 44. Position each tube pair 28 (FIG. 1) at the desired angle to the other, then tighten bolts 48. Now loosen the individual locking collars 36 that hold the outer and inner tubes 38 and 40 of each tube pair 28 (FIG. 1) in place. Extend each tube pair 28 (FIG. 1) to its desired length and tighten each locking collar 36. Next, attach a microphone (not shown in the drawings) to the stud 32 at the microphone end of the boom pole 20 (FIG. 1), and attach an audio cable (not shown in the drawings) to the microphone. Depending on the established configuration, the boom pole 20 (FIG. 1) may be held in a plurality of positions in the hands of, or against the body of, the operator. Or, the boom pole 20 (FIG. 1) may be mounted statically by inserting a static mounting device (not shown in the drawings) into the boom butt chamber 56 located at the operator end of the boom pole 20 (FIG. 1), and then tightening the locking knobs 58. The boom pole 20 (FIG. 1) may then be adjusted as needed, by manipulating the above-mentioned controls, to accommodate lighting or other production equipment.

### CONCLUSIONS, RAMIFICATIONS, AND SCOPE

Accordingly, the reader will see that the combination of telescoping, rotation, and articulation provided by the telescoping, articulating boom pole of this invention provides mounting, operator control, and configuration capability not possible with prior art. Additional advantages are:

The articulating boom pole of this invention can be easily manipulated into a variety of configurations that accommodate the demands of the camera frame and still allow the operator to remain in a comfortable position for extended periods of time.

It can easily be configured to rest against the operator's body at the belt line and be held with one hand for extended periods of time, freeing the other hand to “ride” the audio levels or attend to other production demands.

It can be configured in a straight-line or an angular manner that provides flexibility when shooting on the fly in tight or awkward situations.

The articulating joints allow the operator to “bend” the boom around the frame and walk alongside the talent in a comfortable position with the boom butt resting against his/her body during a “trucking” or moving, shot.

The combination of telescoping and articulation allows the operator to stand directly behind the camera operator and “boom up and out” over the camera in tight situations and position the microphone near the talent. The operator can then remain in a comfortable position with the boom butt resting against the belt line. This is true whether the camera operator is moving or stationary.

The boom pole of the present invention can be positioned in a complex array of static-mounted configurations that accommodate scenery, lighting, and other production equipment found on the set.

The boom butt of the present invention allows the boom pole to be mounted in static locations heretofore not accessible with traditional boom poles. The boom butt also allows the boom to be use without an operator.

The present invention provides a technology that can be readily applied to existing research and development across a wide range of quality and price in the audio boom market with minimum retooling.

While a particular embodiment of the invention has been shown and described, it will be obvious to those skilled in the art that changes and further modifications may be made without departing from the scope of the invention in its broader aspects. The present embodiment is, therefore, to be considered in all respects as illustrative and not restrictive. It should be understood that the following claims are intended to cover all of the generic and specific features of the invention herein described and all statements which, as a matter of language, might be said to fall within the true spirit and scope of the invention.

I claim:

1. A boom pole for use to suspend and position an audio/video capturing device comprising:
(a) a boom pole having a first end and a second end, said boom pole having a plurality of independent sections;
(b) means for interconnecting and providing articulation between said independent sections;
(c) means for interconnecting said first end of said boom pole to said audio/video capturing device.
(d) means for attaching said second end of said boom pole to a structural support.
Whereby said independent sections of said boom pole may be configured in combination at a plurality of angles to one another, and whereby an operator may exercise complex control over the suspension and positioning of an audio/video capturing device, and whereby an operator may use said boom in a comfortable position over extended periods of time, and whereby said boom may be mounted on a structural element, thereby freeing the operator to perform other tasks.

2. A boom pole for mechanical mounting, and for use by an operator, to suspend and position an audio/video capturing device comprising:
(a) a boom pole having a first end and a second end, said boom pole having a plurality of independent telescoping tube pair sections;
(b) means for interconnecting and providing articulation between said independent telescoping tube pair sections;
(c) means for interconnecting said first end of said boom pole to said audio/video capturing device.
(d) means for attaching said second end of said boom pole to a structural support.

3. A boom pole as defined in claim 1, wherein each said independent section comprises a telescoping tube pair.

4. A boom pole as defined in claim 3, wherein each said telescoping tube pair comprises at least a first elongated tube and a second elongated tube telescopically received by and extensible from said first elongated tube.

5. A boom pole as defined in claim 4, additionally comprising means for locking said first elongated tube and said second elongated tube of each said tube pair in place in relation to one another to prevent relative extension or retraction of said second elongated tube.

6. A boom pole as defined in claim 1, wherein means for interconnecting and providing articulation between said independent sections comprises a joint mechanism.

7. A boom pole as defined in claim 6, wherein said joint mechanism comprises:
(a) a first joint head having a first end and a second end;
(b) a second joint head having a first end and a second end;
(c) a joint link plate having a first end and a second end;
(d) means for securing said joint link plate to said joint heads.

8. A boom pole as defined in claim 7, said first joint head having a first radial corrugated face disposed along the longitudinal axis of said first joint head at said first end of said first joint head, said first radial corrugated face further having a threaded aperture at its core.

9. A boom pole as defined in claim 7, said second joint head having a second radial corrugated face disposed along the longitudinal axis of said second joint head at said first end of said second joint head, said second radial corrugated face further having a threaded aperture at its core.

10. A boom pole as defined in claim 7, said joint link plate having top, bottom, and opposite side surfaces, said joint link plate further having third and fourth radial corrugated faces disposed along the longitudinal axis of said bottom of said joint link plate at said first and second ends of said joint link plate respectively, each said third and fourth radial corrugated face adapted to mate said first and second radial corrugated faces of said first and second joint heads respectively, as mentioned in claims 8 and 9 respectively.

11. A boom pole as defined in claim 10, wherein said third and fourth radial corrugated faces of said joint link plate each has a third and fourth aper-ture respectively at its core extending from said top to said bottom through the body of and laterally to the longitudinal axis of said joint link plate.

12. A boom pole as defined in claim 7, wherein said means for securing said joint link plate to said joint heads comprises two thumbscrews.

13. A boom pole as defined in claim 12, wherein said thumbscrews have threaded shafts, said thumbscrews being adapted to extend through said third and fourth apertures mentioned in claim 11 and secure into said joint heads.

14. A boom pole as defined in claim 1, having means for attaching said boom pole to a structural support element comprising:
(a) a mounting device having a first end and a second end;
(b) means for interconnecting and providing articulation between said mounting device and said second end of said boom pole.

15. A boom pole as defined in claim 14, wherein said mounting device comprises:
(a) a third joint head located at said first end of said mounting device;
(b) a chamber located at said second end of said mounting device, said chamber extending into and along the longitudinal axis of the body of said mounting device

16. A boom pole as defined in claim 14, wherein said means for interconnecting and providing articulation between said mounting device and said second end of said boom pole comprises a joint mechanism, comprising:
(a) a third joint head located at said first end of said mounting device;
(b) a fourth joint head having a fifth end and a sixth end, said fifth end being secured into said second end of said boom pole;
(c) a second joint link plate having a third end and a fourth end;
(d) means for securing said second joint link plate against said third and fourth joint heads.

17. A boom pole as defined in claim 16, wherein said third joint head comprises a third radial corrugated face disposed along and lateral to the longitudinal axis of said mount at said first end of said mount, said third radial corrugated face further having a fourth threaded aperture at its core.

18. A boom pole as defined in claim 16, wherein said fourth joint head comprises a fourth radial corrugated face disposed along and lateral to the longitudinal axis of said fourth joint head at said sixth end of said fourth joint head, said fourth radial corrugated face further having a fifth threaded aperture at its core.

19. A boom pole as defined in claim 14, wherein said means for securing said second joint link plate against said third and fourth joint heads comprises two second thumbscrews, each having a third and fourth threaded shaft respectively, each said third and fourth threaded shaft being adapted to secure into said third and fourth joint heads respectively,
Whereby said independent sections of said boom arm may be configured on a plurality of combinations of vertical and horizontal axes at a plurality of angles to one another, allowing precise control over the suspension and positioning of said audio/video capturing device, thereby allowing said boom arm to be hand-held in a comfortable position for extended periods of time,
whereby said boom arm may be surface mounted, allowing said boom arm to be placed in remote locations and configurations heretofore not possible with traditional booms.

20. A method of suspending and positioning an audio/video capturing device, comprising the steps of
(a) providing said audio/video capturing device which can be held or mounted in said specific location and position, and
(b) providing a plurality of telescoping tube pairs, and
(c) providing a plurality of articulating joints which join said telescoping tube pairs and allow said telescoping tube pairs to be juxtaposed to one another in a plurality of positions.
(d) providing a mounting device at second end of said boom pole assembly upon which said audio/visual device may be mounted
(e) providing a mounting device at first end of said boom pole assembly which can be manipulated in order to statically mount said boom pole assembly.
whereby said audio/visual device can be held or mounted in a plurality of configurations, and
whereby said operator can place and/or mount said audio/visual device in a plurality of said locations and positions and accommodate a plurality of physical restrictions characteristic of said location and position.
